(19) United States
(12) Patent Application Publication
(10) Pub. No.: US 2019/0186672 A1
(43) Pub. Date: Jun. 20, 2019

(54) METHOD FOR REPAIRING A TUBULAR

(71) Applicant: Ecosse Global UK Ltd, Dundee (GB)

(72) Inventor: Ernest COUTTS, Dundee (GB)

(73) Assignee: Ecosse Global UK Ltd, Dundee (GB)

(21) Appl. No.: 16/327,979

(22) PCT Filed: Aug. 23, 2017
(86) PCT No.: PCT/GB2017/052483

§ 371 Date: Feb. 25, 2019

(30) Foreign Application Priority Data
Aug. 29, 2016 (GB) 1614608.6

(51) Int. Cl. F16L 55/165; F16L 55/18

(52) U.S. Cl. CPC F16L 55/165; F16L 55/18; F16L 55/1656

(57) ABSTRACT

A method for lining at least a portion of the inner wall of an upstanding tubular includes inserting a liner sleeve into the tubular. The liner sleeve includes a sleeve of flexible sheet material impregnated with and/or coated with a curable polymer composition. The liner sleeve is held in a tubular and a liner sleeve locating tool is inserted into the tubular and inside the liner sleeve. Operating the liner sleeve locating tool holds the outer surface of the liner sleeve in contact with the inner surface of the tubular; and curing the polymer composition bonds the liner sleeve to the inner wall. Alternatively the liner sleeve may be filled with fluid to hold its outer surface in contact with the tubular to allow curing and bonding

### FIELD OF THE INVENTION

The present invention relates to the provision of methods and apparatus for lining tubulars, in particular for reinforcing and/or repairing upstanding tubulars such as are used on offshore oil and gas installations.

### BACKGROUND TO THE INVENTION

Offshore oil and gas installations make use of upstanding tubulars for the supply of water (seawater) for various uses on board, including firefighting. The tubulars may be caissons, upstanding and extending to under the water surface where they are open ended. Caissons and other tubulars, typically made of steel, are subject to corrosion and wear, leading to holes and cracks and general weakness over time.

In situ repair or replacement of tubulars can be difficult and expensive. Individual holes in the underwater parts of caissons may be repaired by diver operations, including for example, by welding of patches over holes.

Other approaches include swaging techniques. A metal liner sleeve section is inserted into the tubular and expanded outwards to jam securely to the inner wall, covering a hole or other defect. This approach can only be used where the caisson is sufficiently structurally sound (apart from at the defect) to accept the pressures of the swaging technique. A further alternative is to fit a long, even full length, metal liner inside the original tubular. This can add significantly to the weight to be supported from the oil or gas platform.

Furthermore as height above the tubular may be restricted, fitting of a metal liner may have to be done by insertion of one short sleeve section after another, with welding operations to join them, as they are inserted into the top of the tubular. Thus it may be decided to replace the tubular, which is itself an expensive and complex operation.

There is therefore the need for improved methods to reinforce and/or repair tubulars that can be economic and effective in use.

### DESCRIPTION OF THE INVENTION

According to a first aspect the present invention provides a method for lining at least a portion of the inner wall of an upstanding tubular; the method comprising:
a) inserting a liner sleeve into a said tubular; wherein the liner sleeve comprises a sleeve of flexible sheet material impregnated with and/or coated with a curable polymer composition;
b) holding the liner sleeve in the tubular;
c) inserting a liner sleeve locating tool into the tubular and inside the liner sleeve;
d) operating the liner sleeve locating tool to hold the outer surface of the liner sleeve in contact with the inner surface of the tubular; and
e) curing the curable polymer composition to bond the liner sleeve to the inner wall of the upstanding tubular.

The method described herein is of particular utility when used to line a substantial length, even the whole length, of an upstanding tubular. Especially where the tubular is a caisson of an offshore oil or gas installation. The liner can cover defects such as holes or cracks in the tubular material and also provide reinforcement to the tubular structure as a whole, extending its life and effectiveness in use. The liner may be relatively thin and so does not have a significant effect on the available volume inside the tubular. Alternatively, where the tubular is generally sound, a repair can be effected by lining a relatively short section of the tubular as described in more detail hereafter.

The method may include preliminary steps such as inspection of the interior of the tubular and cleaning or other surface preparation steps. For example, before insertion of the liner sleeve into the upstanding tubular the inner surface of the tubular may be cleaned by high pressure water jet cleaning.

The liner sleeve may be held in the tubular by fixing the upper end of the liner sleeve at or near the upper end of the tubular. For example the upper end of the liner sleeve may be clamped to the tubular. Conveniently the upper end of the liner sleeve is opened out and a portion of the top end turned outwards over the top edge of the upstanding tubular; to form a turned over end. This turned over end may then be secured to the tubular, for example by means of a clamp. A ring clamp, clamping the turned over end to the outside of the tubular around its circumference is convenient. This allows ready access to the interior of the tubular for operation of the liner sleeve locating tool.

As an alternative, especially convenient where only a relatively short section of tubular is to be lined, or where the section of tubular to be lined is distal from the top end of the tubular, the liner sleeve may be held in the tubular, by the liner sleeve locating tool.

Thus the liner sleeve locating tool may be fitted inside the liner sleeve before the liner sleeve is put into the tubular. The liner sleeve locating tool is lowered into the tubular (for example on a cable controlled by a hoist) with the liner sleeve held to its outer surface or surfaces. When the liner sleeve is at the desired depth the lowering is halted. Operating the liner sleeve locating tool holds the outer surface of the liner sleeve in contact with the inner surface of the tubular. In this embodiment of the method the liner sleeve locating tool may comprise an inflatable tube or other shaped bladder of flexible sheet material, as discussed further below and with respect to certain embodiments. Alternatively the liner sleeve locating tool may comprise a mechanical system such as panels that move radially outwards to hold the liner sleeve against the tubular. The panels may be moved by drive means such as pneumatics, hydraulics or motor drive(s).

The liner sleeve locating tool may be a tube of flexible sheet material that is activated by inflating with fluid. In use, this inflating tube may extend to at least the full length of the liner sleeve where it is located inside the tubular. Inflating the tube of flexible sheet material with fluid fills the interior volume of the tubular, contacting the sleeve liner with the inner surface of the tubular, along the length of the sleeve liner as far as the inflating tube extends. The inflating tube has a closed or closable distal end to allow it to fill with fluid supplied at an open proximal end or through a port or valve in the inflating tube, typically at or near the proximal end. The proximal end is proximal to the top end of the tubular, in use. In some embodiments a housing is fitted to the top end of the tubular. The fluid supplied to fill the inflating tube may be supplied through the housing, for example through a port or valve in the housing.

The fluid employed to inflate the tube of flexible sheet material may be a gas or a liquid. Conveniently for many applications the fluid is water, for example sea water. When the method is employed in reinforcing or repairing an upstanding tubular of an offshore oil and/or gas installation, sea water is particularly convenient. Sea water is routinely used for many purposes in such installations, and so is readily available on the installation.

The use of liquid, especially water, as inflation fluid is advantageous when the upstanding tubular contains water in normal use. For example when the method is employed to repair or reinforce a caisson or other water containing upstanding tubular. The inflating tube displaces the original water content from the tubular via an opening from its interior, such as the open bottom end of a caisson. Water or other liquid may be pumped into the inflating tube, from the top end of the upstanding tubular. For example, by pumping water into an open end of the inflating tube. The weight of the water pumped in displaces the original water in the upstanding tubular. As it inflates, the inflating tube acts on the liner sleeve, pushing its outer surface into good contact with the inner wall of the upstanding tubular.

A slight pressure may be employed with the liner sleeve locating tool, to ensure good contact, and aid firm bonding, between the curable polymer composition of the liner sleeve with the inner wall of the tubular.

Where an inflating tube is employed the fluid may be pressurised. Where liquid is employed as the inflating fluid, only a slight overpressure has been found to be effective. For example, of the order of 0.1-1.5 bar can be effective. Higher pressures may be employed if desired. A suitable small overpressure can be readily achieved. For example by having the inflating tube filled with water to above the height of the top end of the liner sleeve, typically to above the top end of the tubular. This provides a head pressure, which has been found sufficient to assist in the development of a good bond between the liner sleeve and the tubular itself.

In a particularly convenient method the inflating tube is operated (inflated) and deployed down the tubular in a single process step. In this method an end of the inflating tube is held open at or above the upper end of the tubular, for example by being fixed to a ring (that may be part of a jig or frame) placed at or above the upper end of the tubular. The inflating tube may be held open by attachment to the top of the upstanding tubular or to a housing attached to the top of the tubular.

The inflating tube is partly, typically mostly, turned inside out. The length of the inflating tube extends downwards for a short distance from its held open end and then turns inwards and then upwards, away from the held open end; to its closed or closable end. This produces a “turn up” end of the inflating tube—akin to a turn up in a trouser leg i.e. there is a length of downwards directed tube before the tube turns back upwards inside itself with an inside out portion of inflating tube extending to the closed or closable end. This turn up end may extend into the upstanding tubular. The other end (the closed or closable end) of the inflating tube may be held directly above the fixed open end, for example by a cable of a hoist. Conveniently, especially where the inflating tube is of some length, and height is restricted, the inside out portion of tube may run, by means of a hoist arrangement, from the held open end to wind onto a drum or other winding arrangement. This type of hoist arrangement is convenient as described further hereafter and with reference to a specific embodiment.

Water or other fluid is introduced into the turned up end and the inside out portion of the inflating tube is fed into the held open end. The weight of a fluid such as water aids in deploying the inflating tube down into the tubular. The deployment is controlled by the rate of water fill and/or by controlling the rate of feeding the inside out portion into the held open end. For example the movement of the inside out portion of the inflating tube is determined by controlled unwinding from a drum.

Filling with water continues as the inflating tube deploys down the upstanding tubular, until the inflating tube fills the volume of the tubular, at least along the length of the liner sleeve. The inflating tube may be allowed to turn completely or substantially completely, the right way out. An overpressure may be applied by pump pressure, using a head of water above the sleeve liner, or by gas pressure. The overpressure forces the inflating tube to hold the sleeve liner in firm contact with the inner wall of the tubular. Where an overpressure of liquid or gas pressure (other than a head pressure) is employed a sealing connection between the held open end (the top end) of the inflating tube and the source of liquid or gas is required. For example a housing may be provided at the top of the tubular, in sealing connection with the tubular and the source of liquid or gas. A housing may also be employed when a head of water is used to supply the overpressure. The housing fits to the top end of the tubular and may be filled at least partially with liquid (typically water or seawater) to give a head pressure.

This deployment and inflating method for the inflating tube has advantages. Smooth controlled inflation of the inflation tube may be achieved. The liner sleeve, inserted in the tubular, is not subject to unwanted shearing forces (downwards pushing) that might be caused if the inflating tube were to be simply pushed down into the tubular inside the liner sleeve.

The filled inflating tube is held inside the tubular to allow curing of the polymer composition, and to bond the sleeve liner to the inner wall of the tubular. The inflating tube is then withdrawn. Conveniently the inflating tube is withdrawn by use of a cable attached to its closed or closable end that was used in the deployment process. The inflating tube is peeled away from the liner sleeve and turned inside out again. The water or other liquid filling the inflating tube may be displaced from the top end of the tubular as the recovery of the inflating tube is carried out. Alternatively the bottom end of the inflating tube (the closed or closable end) is opened or punctured to allow the egress of water or other liquid as the inflating tube is lifted out of the tubular.

Typically, in the methods of the invention, the liner sleeve locating tool is removed after curing of the curable polymer composition.

However, in some cases, for example where an inflating tube is of a material that tends to bond well to the liner sleeve on curing of the curable polymer composition, the inflating tube may not be removed, but left in situ. The closed or closable end of the inflating tube is then opened, for example by ultra-high pressure (UHP) water jet cutting. This allows the tubular to function with the liner sleeve and the inflating tube remaining in place.

Another example of not removing the locating tool could be where the tool is mechanical, comprising radially outwardly moveable panels, The deployed tool could in some circumstances be left in situ to add to the strength of the repair, as a bracing arrangement.

A further alternative is where the sleeve liner may itself is used as the inflating tube. In this example of the method the sleeve liner itself has a closed or closable end. After insertion of the liner tube into the upstanding tubular, water or other fluid may be used to inflate the sleeve liner to hold it in contact with the tubular wall. After curing the closed or closable end of the sleeve liner is opened for example by ultra-high pressure (UHP) water jet cutting.

Thus in accordance with another aspect the present invention also provides a method for lining at least a portion of the inner wall of an upstanding tubular; the method comprising:
a) inserting a liner sleeve into a said tubular; wherein the liner sleeve comprises a sleeve of flexible sheet material impregnated with and/or coated with a curable polymer composition and has a closed or closable end;
b) holding the liner sleeve in the tubular with the closed or closable end distal to the top end of the tubular;
c) filling the liner sleeve with fluid to hold the outer surface of the liner sleeve in contact with the inner surface of the tubular;
d) curing the polymer composition to bond the liner sleeve to the inner wall of the upstanding tubular; and
e) opening the closed or closable end of the liner sleeve.

The method in accordance with this aspect of the invention can make use of the techniques described herein for the other aspects of the invention. For example holding the liner sleeve in the tubular by means of clamping; the use of a housing at the top of the tubular; types of curable composition; pressurising of the fluid to ensure good contact with the tubular wall; and making use of water, for example sea water, as the inflating fluid. Furthermore the liner sleeve may be deployed by the same turning inside out process described in respect of the inflating tube used in other aspects of the methods of the invention.

The liner sleeves employed in the aspects of the invention is impregnated with and/or coated with a curable polymer composition. Suitable curable polymer compositions are known and commercially available. The polymer composition bonds with the inner wall of the tubular which is typically metal, usually a steel. Curable epoxy resin polymer compositions that will bond to steel or other materials; and cure under water, including under seawater, are commercially available. Such curable epoxy resin compositions can cure at relatively low temperatures such as those found in sea conditions. For example, at say 0 to 10° C. The cure time can be selected by choice of composition to allow the method to be carried out. Thus curing the polymer composition to bond the liner sleeve to the inner wall of the upstanding tubular may only require waiting for the required amount of time, with the outer surface of the liner sleeve held in contact with the inner surface of the tubular

Epoxy resin compositions can bond well to a steel tubular and cure to a solid that retains some flexibility.

The flexible sheet material of the liner sleeve may comprise, consist of, or consist essentially of a fabric that is woven, non-woven, or knitted in construction. The flexible sheet material may be provided as a seamless tube or the sheet may be stitched or otherwise bonded, one edge to another to form a sleeve structure. Thus the combination of a sleeve of flexible sheet material and a curable polymer composition can provide a liner sleeve of a fibre reinforced plastic, when cured. Glass fibre is a suitable material for impregnating and coating with a curable polymer composition. Suitable glass fibre fabrics are commercially available. Woven or knitted fabrics can be accommodating of different tubular diameters. They can expand at least slightly, when under pressure, to provide a snug fit of the liner sleeve to the tubular, without thinning excessively. Other fibres may be used additionally or alternatively. For example carbon and/or aramid fibres may be utilised in some applications.

The sleeve of flexile sheet material may comprise more than one layer of flexible sheet material. For example two, three or four layers of a woven glass fibre fabric. Where multiple layers of fabric are employed they may be separate or attached to each other, for example by stitching.

One or more strength members may be included, attached to or be inside the flexible sheet material. For example longitudinally and/or circumferentially and/or helically running wires, cables or twisted yarns of fibre. If the strength members are attached to the flexible sheet material they may be woven into it, placed between layers of it, and/or bonded to it. If the strength members are not attached to the flexible sheet material they may be attached by the curable polymer composition when the sheet material is impregnated or coated by it.

Where the curable polymer composition impregnates through or is coated onto the sleeve of flexible sheet material of the liner sleeve it will contact an inflating tube when that is used in the method. In such cases the material of the inflating tube may be chosen to allow its removal at the end of the process. Where an epoxy resin composition is chosen an inflating tube of a rubber, for example a low energy surface rubber and/or a reinforced rubber can serve, as it can be peeled away from the cured resin surface. A PVC plastic or a silicone rubber may also be employed. A release agent may be used as a surface coating on the inflating tube.

The liner sleeve is inserted into the upstanding tubular, to extend downwards. The liner sleeve, when the curable polymer composition has been cured, bonds to the inner wall of the tubular. The liner sleeve is sized to fit to the inner wall of the tubular. Therefore to deploy the liner sleeve into the tubular it is reduced in diameter from the fully opened out state where it will contact all around the tubular wall. The reduction in diameter may be due to the sleeve of flexible sheet material being woven or knitted and so expandable when the liner sleeve locating tool is operated. The reduction in diameter may be, for example, by crimping, folding or pleating the tubular shape of the sleeve. Conveniently the liner sleeve, before curing, (or final curing), of the curable polymer composition is folded from the open tubular shape by a single, inwards directed, longitudinal fold. A liner sleeve folded in this way has a generally heart shaped cross section (when viewed across the diameter). This single fold is readily opened out by the action of the locating tool, such as a tool including an inflating tube. Alternative folding arrangements such as folding in a manner akin to pleating (Zig-zag folding longitudinally) may be used.

Typically the tubular may be filled with water or partially filled with water while the liner sleeve is being passed down the tubular. The liner sleeve and curable polymer composition combination are either sufficiently stiff and/or dense to be fed down into the tubular even if water filled. Alternatively or additionally a weight or weights may be may be attached to the liner sleeve to ensure sinking down the tubular.

The sleeve of sheet material may be impregnated and/or coated with the curable polymer composition provided as a fluid; such as a liquid, gel or paste. Such curable polymer compositions may contain solids. Conveniently for many applications the sheet material is treated with the curable polymer composition at or near the site of the tubular to be lined. This may be required where the curable polymer composition cures within a specific, relatively short time frame, after mixing of its components and/or adding a catalyst to start curing.

Conveniently the sheet material is placed into or passed through a bath of curable polymer composition and then the sleeve liner is fed into the upstanding tubular. For example, passing the sleeve of flexible sheet material through a bath of curable polymer composition and then down the tubular to be lined. This approach allows more time to complete the location of the liner sleeve, against the inner wall of the tubular, before curing can stiffen the liner sleeve or even set it solid, which would prevent correct deployment. As an alternative to providing a bath of curable polymer composition the application of composition to the sleeve of sheet material may be done by the use of another application means; such as rollers (“coating rollers”), a spray nozzle or nozzles as the sleeve is passed down the upstanding tubular.

A more or less continuous process is convenient.

A machine for liner sleeve deployment may be provided. The machine may include: a drum for holding the sleeve of flexible sheet material before deployment; and drive means to move the sleeve of flexible sheet material from the drum, and down an upstanding tubular.

The machine may also include a coating station where the sleeve of flexible sheet material is impregnated and/or coated with curable polymer composition.

The drive means may include drive rollers between which the sleeve of flexible sheet material or the impregnated and/or coated sleeve of flexible sheet material is driven. Drive rollers may be located above the upstanding tubular in use of the machine. Drive rollers may be located above the upstanding tubular and immediately below a coating station. Alternative drive means may include a motor that drives the drum for holding the sleeve of flexible sheet material unwinding it from the drum. As a yet further alternative the drive means may be manual. For example the sleeve of flexible sheet material may be unwound from a drum by turning a crank by hand.

The coating station may include a bath for holding curable polymer composition. The sleeve of flexible sheet material is passed through the bath. Alternatively the coating station may include one or more coating rollers or one or more spray nozzles or other application means to apply the curable polymer composition from a supply source, such as a holding tank or alternatively a mixer that makes up the composition immediately before application. The coating rollers may be rollers of the drive means.

The machine may fold the liner sleeve. This may be done before or after the application of the curable polymer composition. Alternatively the sleeve of flexible sheet material may be pre-folded before fitting to the machine. Conveniently the sleeve of flexible sheet material may be supplied pre-folded and wound round a drum. The drum is fitted to the machine—as the drum for holding the sleeve of flexible sheet material—before deployment.

In some arrangements the machine for deployment of the liner sleeve may also serve for deployment and recovery of the liner sleeve locating tool. Where the tool includes a tube of flexible sheet material that is activated by inflating with fluid the tube of flexible sheet material may be deployed and recovered by use of the same machine that deploys the liner sleeve.

### BRIEF DESCRIPTION OF THE DRAWINGS

FIG. 1 a shows in schematic partial perspective, a liner sleeve being inserted into a tubular;

FIGS. 1b and 1c show in cross section, a liner sleeve inside a tubular;

FIG. 1d shows in schematic partial perspective (cut-away), a liner sleeve in a tubular;

FIG. 2 shows in in schematic partial cross section, the deployment of an inflating tube in a tubular containing a liner sleeve;

FIG. 3 shows in schematic partial cross section, an inflating tube end inside a tubular;

FIG. 4 shows in schematic perspective, a machine for liner sleeve deployment;

FIGS. 5 and 5a show an alternative machine for liner sleeve deployment;

FIGS. 6a to 6e show in schematic partial perspective views, clamping arrangements; and

FIG. 7 shows in schematic partial perspective view (cut-away) deployment of a sleeve liner in a tubular using a liner sleeve locating tool.

### DESCRIPTION OF THE INVENTION WITH REFERENCE TO SOME EMBODIMENTS

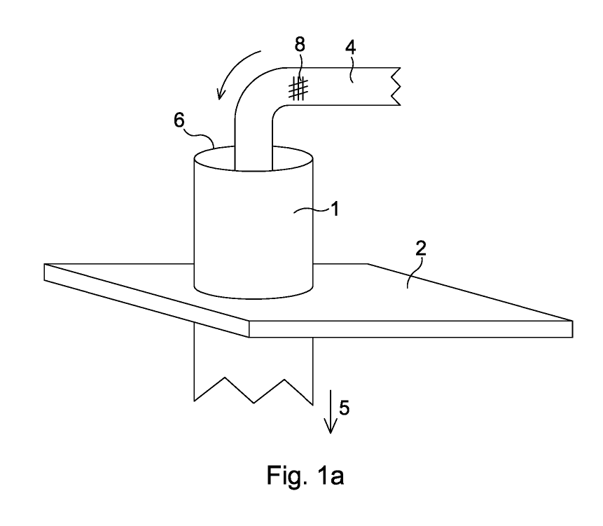

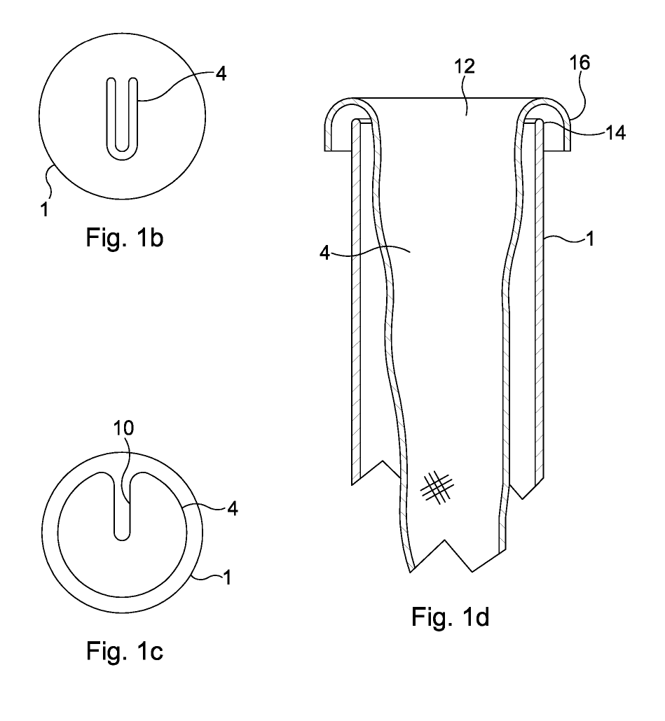

FIG. 1a shows in a partial schematic perspective view an upstanding tubular 1, such as a caisson as can be found on an offshore oil platform, passing through a floor 2, towards the sea (not shown, in the direction of arrow S). A liner sleeve 4 of a woven flexible sheet material that has been impregnated with a curable polymer composition is being fed into the top end 6 of tubular 1. The woven texture of liner sleeve 4 is suggested only by a small area of cross hatch 8, for clarity and simplicity.

FIG. 1b shows the tubular 1 of FIG. 1 a in a plan view, to show the folding of liner sleeve 4 that allows it to pass easily down the tubular. FIG. 1c shows an alternative folding arrangement where the liner sleeve 4 has a single inwardly directed longitudinal fold 10 that allows the liner to adopt a generally “heart shaped” cross sectional shape, of reduced diameter.

FIG. 1d shows a schematic cross-sectional view of tubular 1 with liner sleeve 4 deployed inside the tubular. The top end 12 of the liner sleeve is held open by being turned over the top edge 14 of the tubular to form a turned over end 16.

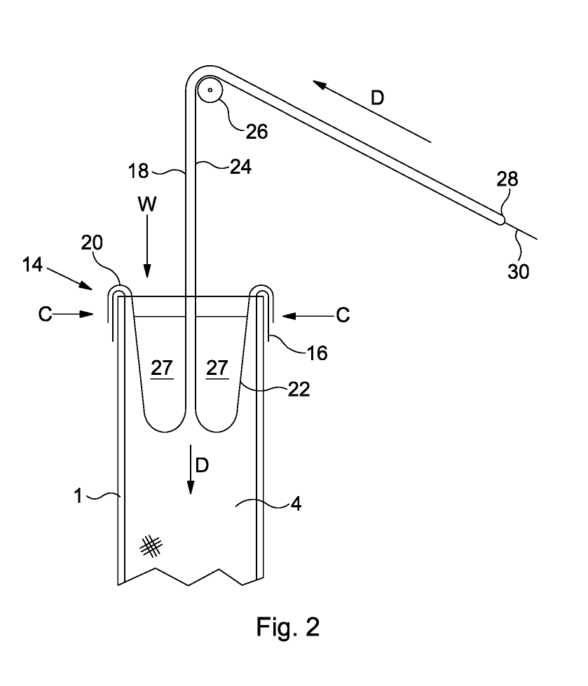

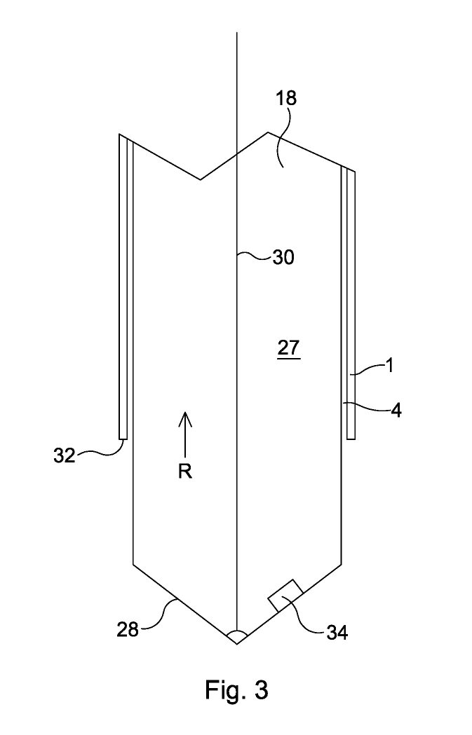

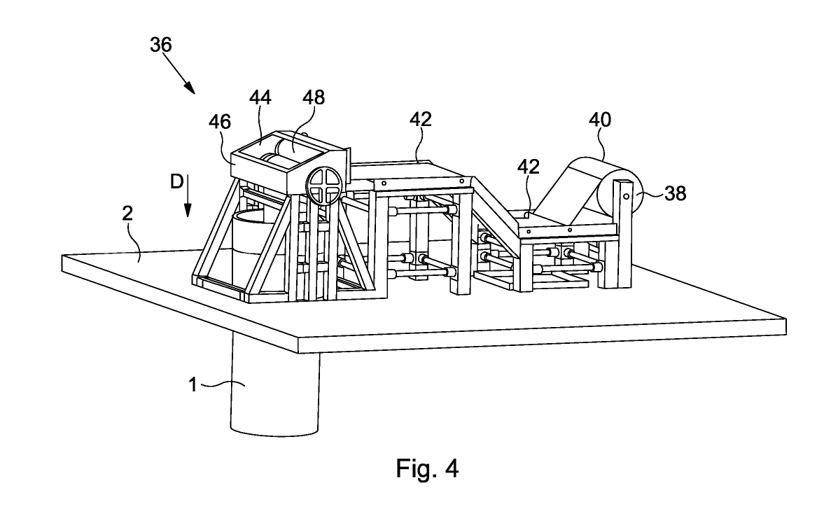

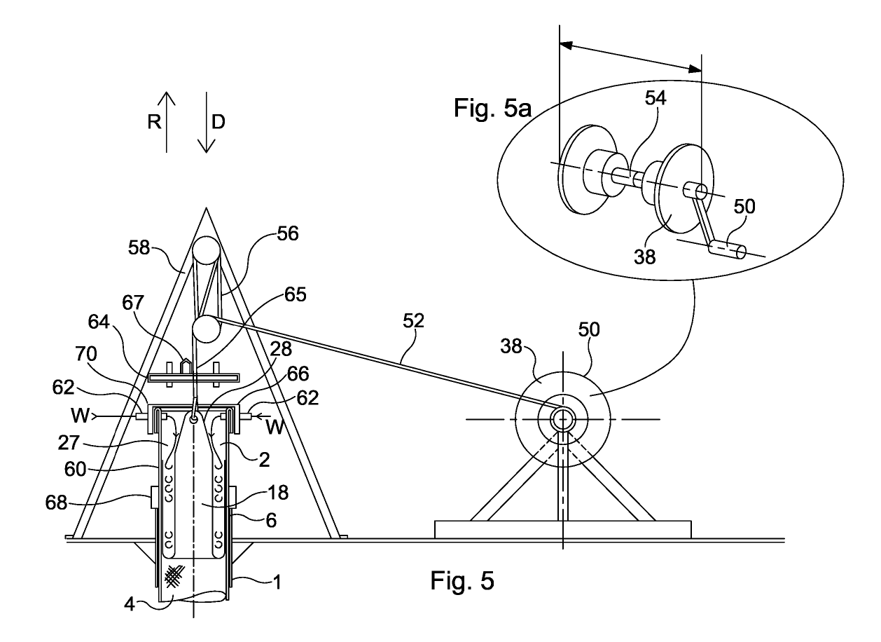

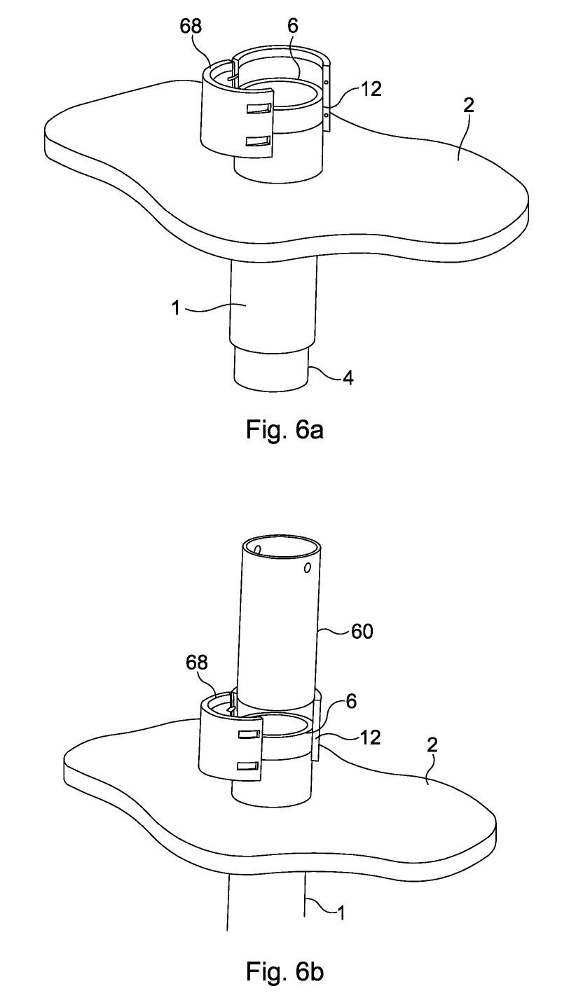

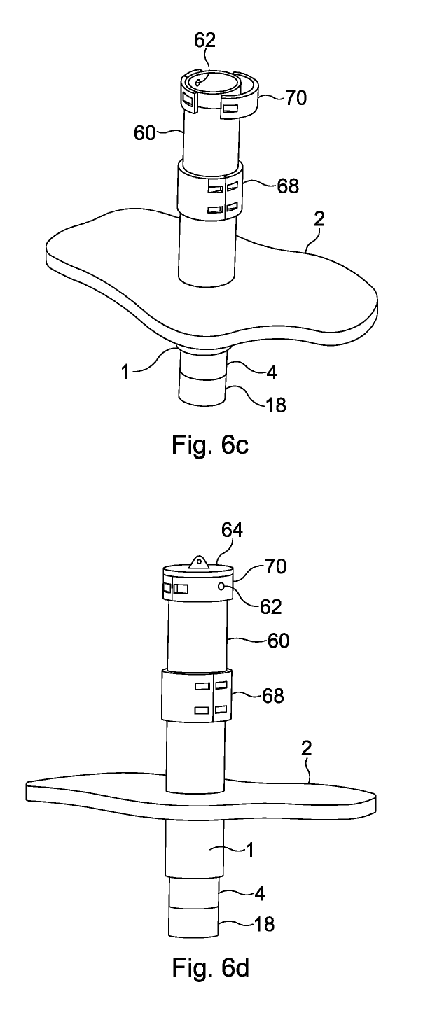

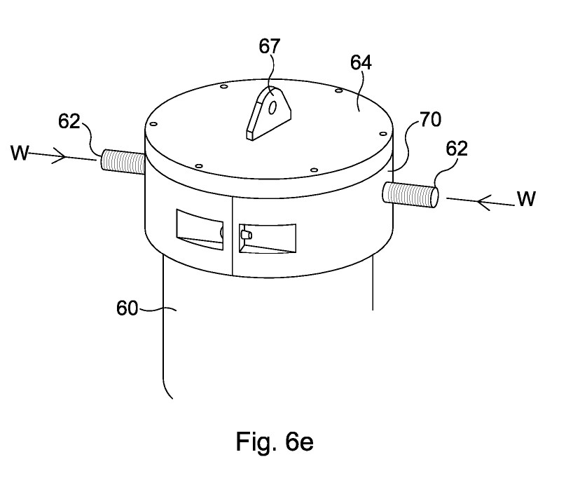

As can be seen in schematic cross section FIG. 2, the turned over end 16 may be clamped into place at the top of the tubular 1 as suggested by arrows C (see also FIG. 6a). Also shown in this figure is an inflating tube 18 (see also FIGS. 3 and 5). The inflating tube 18 has a held open end 20 turned over around the top edge 14 of the tubular 14 in this example. Again clamping in place is suggested by arrows C. The inflating tube 18 extends down into the tubular 1, inside the liner sleeve 4, for a short distance before turning inside out and upwards to form turn up 22. The inside out portion 24 of the inflating tube 18 extends upwards and then around pulley wheel 26 to one side, where the inflating tube ends at a closed end 28 which attaches to the cable 30 of a hoist (not shown, see FIG. 4). As indicated by arrows D the inflating tube 18 is deploying by moving around pulley 26 and down into the tubular 1, assisted by water 27 from a source suggested by arrow W; that fills the turn up 22.

FIG. 3 shows the bottom end 32 of tubular 1 in schematic cross section. In this view the inflating tube 18 is filled with water 27 and fully deployed. The liner sleeve 4 is held in good contact with the inner wall of the tubular 1 until it has cured. After curing is complete the inflating tube is recovered, as suggested by arrow R, from tubular 1 by use of the cable 30 attached to a hoist (not shown). In this example an openable panel 34 at the bottom of the inflating tube 18 may be opened (for example by use of a probe or by cutting with a high pressure water jet), to allow water easy escape as the recovery of the inflating tube 18 is carried out. Alternatively the water in the inflating tube can be removed simply by pumping from the top, e.g. by suction pumps, as the inflating tube is removed or even before the inflating tube is removed. As a further alternative the action of withdrawing the inflating tube may be used to allow the water to overflow from the top of the tubular. In general a controlled exit of water is undertaken as is convenient for the task and location.

FIG. 4 shows in schematic perspective a machine for liner sleeve deployment 36. In this example a drum 38 is loaded with a folded sleeve of flexible sheet material 40 (such as of woven glass fibre), for dispensing via a series of rollers 42 and a coating station 44, down into the tubular 1, as in the schematic view of FIG. 1a. The coating station 44 includes bath 46 for a curable polymer composition. The sheet material 40 is impregnated with curable polymer composition in bath 46 before passing through drive rollers 48 which remove excess polymer composition.

FIG. 5 shows an alternative machine for carrying out the invention. In this example a more manual operation is contemplated. A drum 38 (see detail perspective FIG. 5a) is manually operated by crank handle 50 or by motor (not shown). The drum can be used to deploy a cable 52 attached to a closed end of an inflating tube 18.

In this example the drum 38 includes a reduced diameter central portion 54 that may be employed for coils of the cable 52. The reduced diameter portion may also find use for holding a sleeve of flexible sheet material 40 to be deployed down a tubular before the inflating tube 18 is put into position for its own deployment.

As shown in the figure cable 52 is deploying inflating tube 18 by means of a pulley assembly 56 mounted on a support assembly 58. The tubular 1 is shown in cross section in this figure to allow viewing of the contents. A liner sleeve 4 has already been deployed inside the tubular 1 and is in the process of being held against the inner surface of the tubular 1 by the inflating tube 18 as it descends (turns outside out) and is filled with water 27 from a source W, as suggested by arrow D.

In this example a cylindrical housing 60 is fitted to the top 6 of the tubular 1 and water inlets 62 deliver the water to the interior. After completion of the descent of the inflating tube 18 into the tubular 1, a lid 64, (shown in a raised position) may be fitted onto the top 66 of the housing 60 to allow slight pressurisation of the water 27 to firmly hold the liner sleeve 4 in position until the curable polymer composition it is impregnated and/or coated with, has completed curing. The lid 64 has a passage 65 through it to allow the cable 52 passage. After the lid 64 is put into place for pressurisation, sealant may be used around passage 65 to allow pressurisation.

Alternative arrangements may be made. For example a main cable 52 may attach to a lifting lug or padeye 67 on the top of lid 64 (see also FIG. 6e). A similar lug (not shown) on the underside of the lid 64 may have a secondary cable attached to it that connects to the inflating tube 18 in the same way as cable 52 does in the arrangement depicted in the figure.

The liner sleeve 4 is held at the top 6 of the tubular 1 by clamping ring 68. The inflating tube 18 is similarly held by clamping ring 70 at the top of the housing 60. (See FIGS. 6a to 6e)

After curing of the polymer composition the lid 64 may be removed and the water 27 may be pumped out or simply allowed to overflow out as the inflating sleeve 18 is retrieved as suggested by the arrow R, making use of the cable, pulley and drum system 52, 56, 50. The inflating tube 18 peels away from the liner sleeve 4. The housing 60 and other components of the system may then be removed.

FIGS. 6a to 6e illustrate the clamping arrangements in partial schematic perspective views.

In FIG. 6a, a tubular 1 passing through a floor 2 or deck of an installation; such as an oil rig; has a liner sleeve 4 deployed down through its interior. The top 12 of liner sleeve 4 has been turned over the top edge 6 of the tubular and is being secured in place by a clamping ring 68.

As can be seen in FIG. 6b the clamping ring 68 may be employed to also clamp housing 60 to the top of the tubular 6.

In FIG. 6c the arrangement has an inflating tube 18 fitted inside the liner sleeve 4 which is being clamped by clamp ring 70 to the top of the housing 60. FIG. 6d shows the fitting of a lid 64 to the housing 60 to allow water pressurisation through water inlets 62 (only one visible).

FIG. 6e shows lid 64 and clamp ring 70 in place and in more detail. Also shown is lug 67 for attachment of a cable.

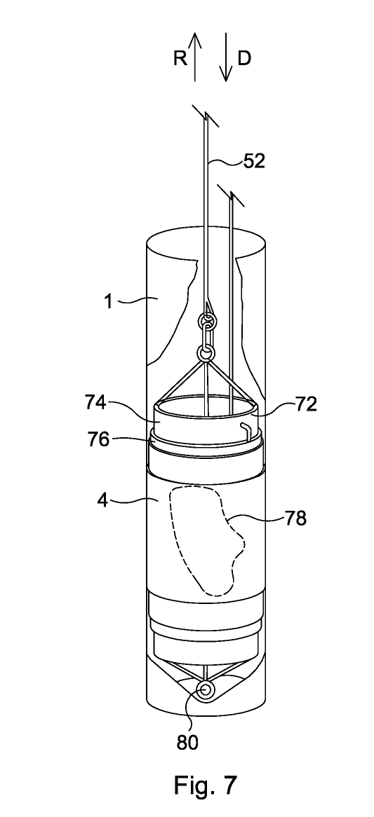

FIG. 7 shows in partial cut away perspective an arrangement for lining a tubular 1 making use of a liner sleeve locating tool to carry the liner sleeve 4 down the tubular 1 and then hold it against the interior surface of the tubular to allow curing and bonding.

As can be seen in the figure, in this example a liner sleeve locating tool 72 includes a cylindrical base 74 (typically of metal) about which an inflatable bladder 76 is disposed. The tool 72 has been deployed down the tubular 1, suspended on cable 52. A liner sleeve 4 coated and/or impregnated with a curable polymer composition is disposed around bladder 74, and held by slight tension caused by partial inflation of the bladder via pipe 78. The inflating fluid employed may be water or a gas for example. The liner sleeve is held at the depth of a defect, such as a hole, in the tubular 1. This is suggested here by dashed line 78. The bladder 74 is then inflated further to hold the liner sleeve firmly against the tubular until the curable polymer composition is cured. The bladder 74 may then be deflated and the tool 72 retrieved (as suggested by arrow R). If required eyelet 80 may be used for attachment of a ballast weight, as an aid to deployment (suggested by arrow D).

1. A method for lining at least a portion of the inner wall of an upstanding tubular; the method comprising:
a) inserting a liner sleeve into a said tubular; wherein the liner sleeve comprises a sleeve of flexible sheet material impregnated with and/or coated with a curable polymer composition;
b) holding the liner sleeve in the tubular;
c) inserting a liner sleeve locating tool into the tubular and inside the liner sleeve;
d) operating the liner sleeve locating tool to hold the outer surface of the liner sleeve in contact with the inner surface of the tubular; and
e) curing the curable polymer composition to bond the liner sleeve to the inner wall of the upstanding tubular.

2. The method of claim 1 further comprising the step of:
f) removing the liner sleeve locating tool.

3. The method of claim 1 wherein the liner sleeve locating tool is an inflating tube of a flexible sheet material that has a closed or closable end and is inflatable by a fluid;
and, optionally, wherein, in use, the inflating tube extends to at least the full length of the liner sleeve.

4. (canceled)

5. The method of claim 1 wherein the liner sleeve locating tool is an inflating tube of a flexible sheet material that has a closed or closable end and is inflatable by a fluid; and,
the fluid employed to inflate the inflating tube is water; and, optionally, wherein the inflating tube is pressurised with fluid when inflated.

6. (canceled)

7. The method of claim 1 wherein the inflating tube is inflated and deployed down the tubular in a single process step; and,
optionally, wherein the single process step is commenced after;
the end of the inflating tube distal to the closed or closable end is held open at or above the upper end of the tubular;
the inflating tube is at least partly turned inside out with the length of the inflating tube extending downwards from its held open end and then turning inwards and then upwards away from the held open end to the closed or closable end; thereby providing a turned up end; and,
optionally, wherein the single process step includes:
introducing liquid into the turned up end as the inside out portion of the inflating tube is fed into the held open end, to deploy the inflating tube down into the tubular.

8. (canceled)

9. (canceled)

10. The method of claim 5 wherein the inflating tube is allowed to turn substantially completely the right way out.

11. The method of claim 1 wherein the liner sleeve locating tool is an inflating tube of a flexible sheet material that has a closed or closable end and is inflatable by a fluid; and
wherein after the curable polymer composition is cured the inflating tube is removed from the tubular by withdrawing by use of a cable attached to the closed or closable end.

12. The method of claim 1, wherein the liner sleeve locating tool is an inflating tube of a flexible sheet material that has a closed or closable end and is inflatable by a fluid; and
wherein the inflating tube is not removed from the tubular.

13. The method of claim 1 wherein a housing is fitted to the top end of the tubular.

14. The method of claim 1 wherein the liner sleeve is held in the tubular by fixing the upper end of the liner sleeve at or near the upper end of the tubular.

15. The method of claim 1 wherein the flexible sheet material of the liner sleeve comprises a fabric that is woven, non-woven, or knitted in construction.

16. The method of claim 11 wherein the fabric is a glass fibre fabric.

17. The method of claim 1 wherein the curable polymer composition is a curable epoxy resin polymer.

18. The method of claim 1 wherein the flexible sheet material of the liner sleeve includes one or more strength members, attached to or inside the flexible sheet material.

19. The method of claim 1 wherein the flexible sheet material of the liner sleeve is impregnated with and/or coated with the curable polymer composition by one of:
passing through a bath of the curable polymer composition;
contacting at least one coating roller coated the curable polymer composition; and spraying with the curable polymer composition.

20. The method of claim 1 wherein the liner sleeve is deployed by a machine including a drum for holding the liner sleeve before deployment; and drive means to move the liner sleeve from the drum and down an upstanding tubular; and,
optionally, wherein the machine includes a coating station for coating and/or impregnating the flexible sheet material of the liner sleeve with the curable polymer composition; and,
optionally, wherein the drive means includes drive rollers.

21. (canceled)

22. (canceled)

23. The method of claim 1 wherein the liner sleeve is held in the tubular by fixing the upper end of the liner sleeve at or near the upper end of the tubular; and wherein the liner sleeve is held in the tubular by the liner sleeve locating tool;
and, optionally, wherein the liner sleeve locating tool is fitted inside the liner sleeve before the liner sleeve is put into the tubular and the liner sleeve locating tool is lowered into the tubular with the liner sleeve held to its outer surface or surfaces.

24. (canceled)

25. The method of claim 17 wherein the liner sleeve locating tool comprises an inflatable tube or other shaped bladder of flexible sheet material fitted to a base.

26. The method of claim 17 wherein the liner sleeve locating tool comprises panels that move radially outwards to hold the liner sleeve against the tubular.

27. A method for lining at least a portion of the inner wall of an upstanding tubular; the method comprising:
a) inserting a liner sleeve into a said tubular; wherein the liner sleeve comprises a sleeve of flexible sheet material impregnated with and/or coated with a curable polymer composition and has a closed or closable end;
b) holding the liner sleeve in the tubular with the closed or closable end distal to the top end of the tubular;
c) filling the liner sleeve with fluid to hold the outer surface of the liner sleeve in contact with the inner surface of the tubular;
d) curing the polymer composition to bond the liner sleeve to the inner wall of the upstanding tubular; and
e) opening the closed or closable end of the liner sleeve.
